(19) United States
(12) Patent Application Publication
(10) Pub. No.: US 2005/0114357 A1
(43) Pub. Date: May 26, 2005

(54) Collaborative media indexing system and method

(76) Inventors: Rathinavelu Chengalvarayan, Santa Barbara, CA (US); Philippe Morin, Santa Barbara, CA (US); Robert Boman, Thousand Oaks, CA (US); Ted Applebaum, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 10/718,471

(22) Filed: Nov. 20, 2003

(51) Int. Cl. G06F 7/00

(52) U.S. Cl. 707/100

(57) ABSTRACT

An indexing system for tagging a media stream is provided. The indexing system includes a plurality of inputs for defining at least one tag. A tagging system assigns the tag to the media stream. A tag analysis system selectively distributes tags for review and editing by members of the collaborative group. A tag database stores the tag and the media stream. Retrieval architecture can search the database using the tags.

### FIELD OF THE INVENTION

The present invention relates to media indexing and more particularly to a collaborative media indexing system and method of performing same.

### BACKGROUND OF THE INVENTION

Multimedia content is steadily growing as more and more is recorded on video. In many cases, for example in broadcasting companies, multimedia libraries are so vast that an efficient indexing mechanism that allows for retrieval of specific multimedia footage is necessary. This indexing mechanism can be even more important when attempting to rapidly retrieve specific multimedia footage such as with, for example, sports highlights or breaking news.

A common method for generating an accurate indexing mechanism used in the past has been to assign a person to watch the multimedia footage in its entirety and enter indices, or tags, for specific events. These tags are typically entered via a keyboard and are associated with the multimedia footage's timeline. While effective, this post-processing of the multimedia footage can be extremely time-consuming and expensive.

One possible solution is to enter tags using speech recognition technology to either enter tags by voice as the multimedia footage is being recorded, or to enter tags by voice in a post-processing step. It would be highly desirable, for example, to permit multiple persons to enter tag information simultaneously while the multimedia footage is being recorded. This has not heretofore been successfully accomplished due to the complexities of integrating, the tag information entered by multiple persons or from multiple sources.

### SUMMARY OF THE INVENTION

The present invention provides a collaborative tagging system, that permits multiple persons to enter tag information concurrently or substantially simultaneously as multimedia footage is being recorded (or after having been recorded, during a post-recording editing phase). In addition to permitting input from multiple users concurrently or simultaneously, the system also allows tag information to be input from automated sources, such as environmental sensors, global positioning sensors and from other sources of information relevant to the multimedia footage being recorded. The tagging system thus provides a platform for using tags having multiple fields corresponding to each of the different sources of tag input (e.g., human tagging by voice and other automated sensors).

To facilitate the editing and use of these many sources of tag input information, the system includes a collaborative component to allow the users to review and optionally edit tag information as it is being input. The collaborative component has the ability to selectively filter or screen the tags, so that an individual user can review and/or edit only those tags that he or she has selected for such manipulation. Thus, the movie producer may elect to review tags being input by his or her cameraman, but may elect to screen out tags from the on-site GPS system and from the multimedia recording engineering unit.

The collaborative media indexing system is fully speech-enabled. Thus, tags may be entered and/or edited using speech. The system includes a speech recognizer that converts the speech into tags. A set of metacommands are provided in the recognition system to allow the user to perform edits upon an existing tag by giving speech metacommands to invoke editing functions.

The collaborative component may also include sophisticated information retrieval tools whereby a corpus of recorded tags can be analyzed to extract useful information. In one embodiment, the analysis system uses Boolean retrieval techniques to identify tags based on Boolean logic. Another embodiment uses vector retrieval techniques to find tags that are semantically clustered in a space similar to other tags. This vector technique can be used, for example, to allow the system to identify two tags as being related, even though the literal terms used may not be the same or may be expressed in different languages. A third embodiment utilizes a probabilistic model-based system whereby models are developed and trained using tags associated with known multimedia content. Once trained, the models can be used to automatically apply tags to multimedia content that has not already been tagged and to form associations among different bodies of multimedia content that have similar characteristics based on which models they best fit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram depicting the collaborative media indexing system of the present invention in an exemplary environment.

FIG. 2 is a schematic diagram of one embodiment of the collaborative indexing system of the present invention;

FIG. 3 is a schematic diagram of a tagging schema which may be used with the collaborative media indexing system of the present invention;

FIG. 4 is a block diagram depicting the information retrieval aspects of collaborative media indexing system of the present invention in an exemplary environment;

### DETAILED DESCRIPTION OF THE PREFERRED EMBODIMENTS

The following description of the preferred embodiment(s) is merely exemplary in nature and is in no way intended to limit the invention, its application, or uses.

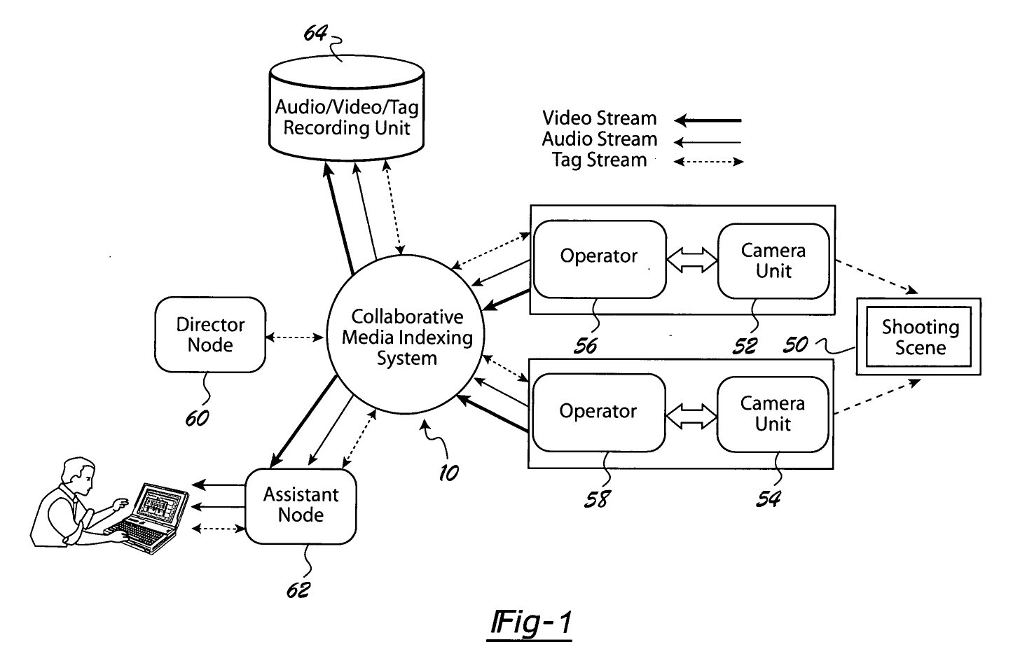

Referring to FIG. 1, the collaborative media indexing system 10 is illustrated schematically in an exemplary environment. A scene 50 is filmed by camera units 52 and 54 operated by operators 56 and 58. Tags may be generated by automatic sensors, such as sensors associated with the cameras 52, 54 and by the operators 56, 58 via spoken commands, all in real-time. The tags are fed to the collaborative media indexing system 10. The tags include an identification of the operators 56, 58, which may be done either by manual input of a user ID or through speech using speaker ID techniques. The ID information is used to designate who entered the tag, and may also serve to prevent unauthorized users from tampering with the tag stream. The tags may further include other information such as detected applause, detecting operator arousal (e.g., heat-rate, galvanic skin response, etc.), confidence values associated with the relative accuracy of tagging information, and copyright data. The tags may be further labeled, either automatically or by an operator, in real-time or during post processing. These labels may include language of the stored tags, and source of the tags (e.g., which automatic procedures used or which operator).

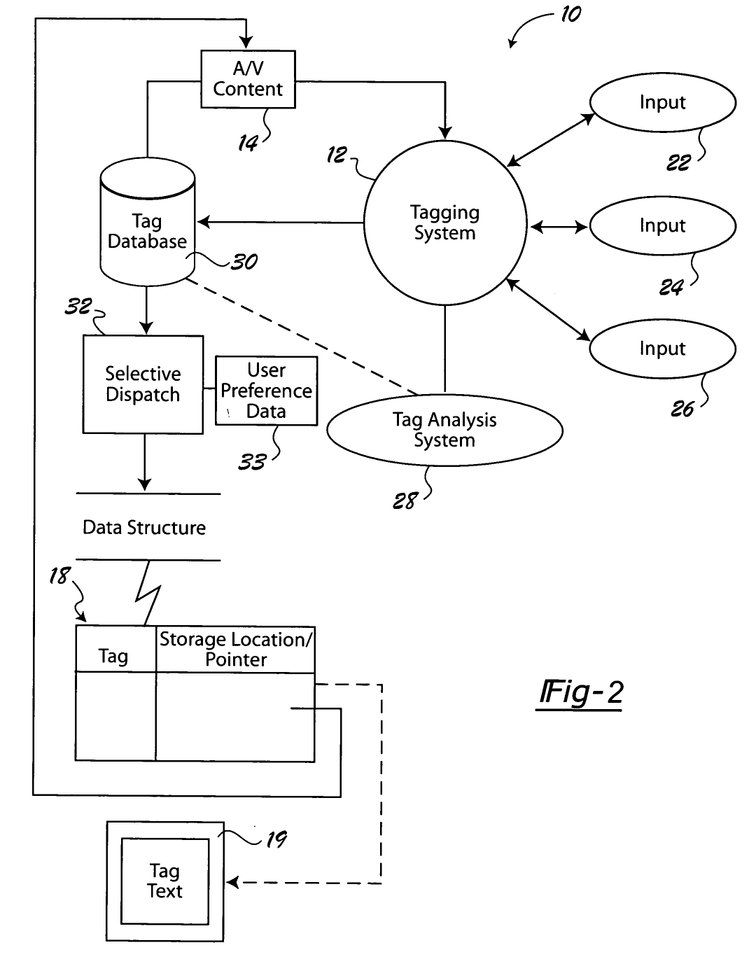

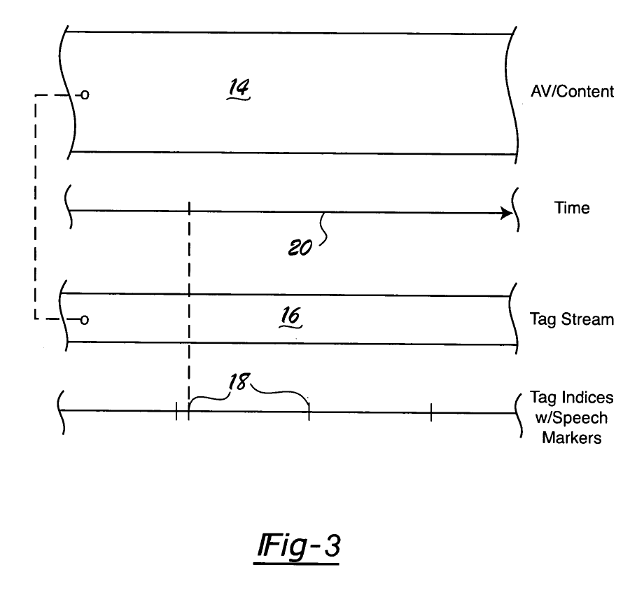

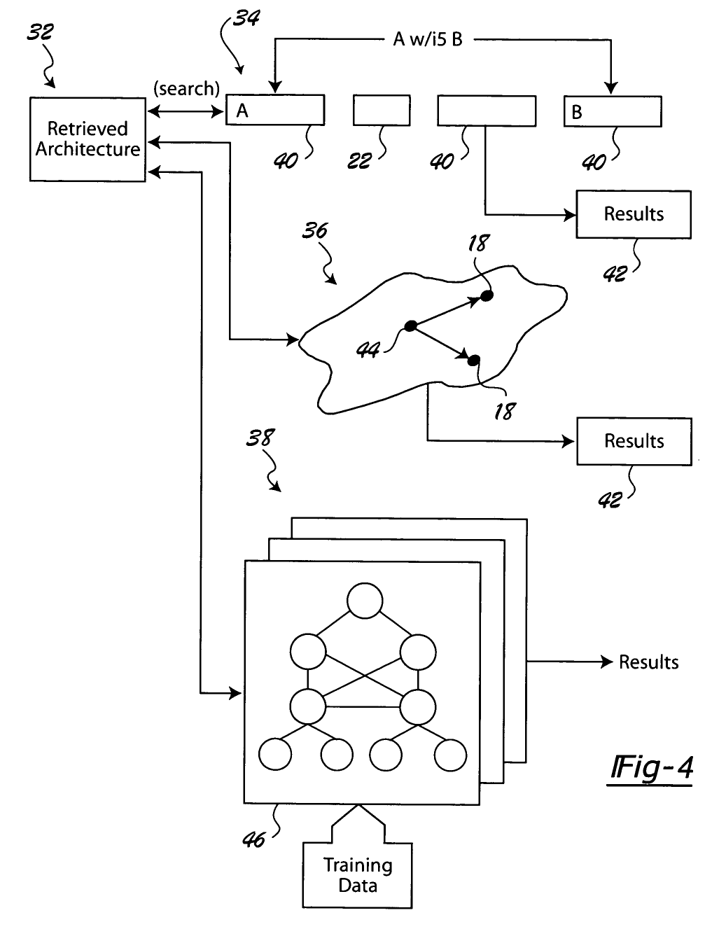

The tags, audio stream, and video stream are fed through the collaborative indexing system 10 where tag analysis and storage are performed. A director 60, or any other operator or engineer, can selectively view the tags on a screen as they are generated by the operators 56, 58 and cameras 52, 54 or hear the tag content spoken through a text-to-speech synthesis system. The director 60 or other user can then edit the tag information in real-time as it is recorded. An assistant 62 may view the video, audio and tag streams in post-processing and edit accordingly, or access retrieval architecture (discussed in connection with FIG. 4 below) to pull specific tags in a query. Tags can be retrieved according to various factors, including who entered the tags. Tags are stored in a database (discussed in connection with FIGS. 2 and 3 below). The database may be embodied as a separate data store, or recorded directly on the recording medium administered by the recording unit 64.

One presently preferred embodiment of the collaborative media indexing system 10 is illustrated in FIG. 2. The collaborative media indexing system 10 includes a tagging system 12 used to collaboratively assign user-defined tags to the audio/video content 14. The tags, as will be described below, are indices of information that relate to the AN content 14. The tagging system 12 may be a computer operated system or program that assigns the tags to the A/B content 14. The A/V content 14 may be embodied as streaming video or audio, or recorded on any other form of media where it would be advantageous to embed tag information therein.

In this regard, tags can be embedded on or associated with the audio/video content in a variety of ways. FIG. 3 is illustrative. In FIG. 3, the combined content of the media 14 after processing by the tagging system is illustrated schematically. The tagging system 12 layers or associates a tag stream 16 into or with the A/V content 14. The tag stream 16 is a stream of information comprised of a plurality of tags 18. Each tag is associated, as illustrated schematically by the dashed line in FIG. 3, with a timeline 20 corresponding to the A/V content 14. The timeline may be represented by a suitable timecode, such as the SMTPE timecode. For example, if the A/V content 14 is a segment of video, then the tags 18 would correspond to individual frames within the video segment. More than one tag 18 can be associated with any segment.

The tags 18 themselves may include a pointer or pointers that correspond to the timeline of the A/V content 14 to which the tag 18 has been assigned. Thus, a tag can identify a point within the media or an interval within the A/V content. The tags 18 also include whatever information a user of the tagging system 12 wishes to associate with the A/V content 14. Such information may include spoken words, typed commands, automatically read data, etc. To store this information, each tag 18 is comprised of multiple fields with each field. designated to store a specific type of information. For example, the multi-field tags 18 preferably include fields to recognized text of spoken phrases, a speaker identification of a user, confidence score of the spoken phrase, speech recording of the spoken phrase, language identification of the spoken phrase, detected scene or objects, physical location where the media was recorded (e.g., via GPS), and a copyright field corresponding to protected works comprising part or all of the A/V content 14. It should be appreciated that any number of other fields may be included. For example, temperature or altitude of the shooting scene may be captured and stored in tags to provide context information useful in later interpreting the tag information.

Returning to FIG. 2, the collaborative media indexing system 10 further includes a plurality of inputs 22, 24, 26 in communication with the tagging system 12. While in the particular example provided, only three inputs are illustrated, it should be appreciated that any number of inputs may be used with the collaborative media indexing system 10. Each input 22-26 may be coupled to any suitable source of information, such as a transducer, sensor, a keyboard, mouse, touch-pen, microphone, or other information system. These inputs thus serve as the source of the information that is stored in the multi-field tags 18. Accordingly, the inputs 22-26 can be coupled to controls on a camera, a keyboard for a director, a global positioning system, or automatic sensors located on a camera that is filming the A/V content 14.

In the case of the controls on the camera, the information from the input may be comprised of a spoken phrase that the tagging system 12 then interprets using an automatic speech recognition system. In the case of the keyboard, the inputs may be comprised of typed commands or notes from a user watching the A/V content 14. In the case of the automatic sensors, the information may include any number of variables relating to what the A/V content 14 is comprised of, or environmental conditions surrounding the A/V content 14. It should be noted that these inputs 22-26 may be either captured as the A/V content 14 is recorded (e.g., in real-time) or at some later point after recording (e.g., in post-production processing).

The tagging system 12 makes possible a collaborative media indexing process whereby tags input from multiple sources (i.e., multiple people and/or multiple sensors and other information sources) are embedded in or associated with an audio/video content, while offering the opportunity for collaborative review. The collaborative review process follows essentially the following procedure:
1. Event is identified by the tagging entity(s) as it is being filmed;
2. Tagging entity applies semantic tag to the event;
3. Tag is dispatched to other users;
4. Content of tag is reviewed by other users; and
5. Contents of tag optionally modified by reviewing entity.

The above process may be implemented whereby the tagging system 12 receives the semantic tag information from the inputs 22, 24 and 26 and stores them in a suitable location associated with the audio/video content 14. In FIG. 2, the tags are stored in a tag database 30. This database can be either implemented as physical storage locations on the media upon which the audio/video content is stored, or stored in a separate data storage device that has suitable pointer structures to correlate the stored tags with specific locations within the audio/video content.

The stored tags are then retrieved and selectively dispatched to the participating users, based on user preference data 33 stored in association with the selective dispatch component 32. In this way, each user can have selected tag information displayed or enunciated, as that user requires. In one embodiment, the individual tag data are stored in a suitable data structure as illustrated diagramically at 18. Each data structure includes a tag identifier and one or more storage locations or pointers that contain the individual tag content elements.

Illustrated in FIG. 2 is a pointer to a tag text element 19 that might be generated using speech recognition upon a spoken input utterance from one of the users. Thus, this tag text could be displayed on a suitable screen to any of the users who wish to review tags that meet the user's preference requirements. The selective dispatch component 32 has a search and retrieval mechanism allowing it to identify those tags which meet the user's preference requirements and then dispatch only those tags to the user. While a tag text message has been illustrated in FIG. 2, it will be understood that the tag text message could be converted into speech using a text-to-speech engine, or the associated tag could store actual audio data information representing the actual utterance provided by the tag inputting user.

The collaborative architecture illustrated in FIGS. 1 and 2 permit the users to produce a much richer and accurate set of tags for the media content being indexed. Users can observe or listen to selected tags provided by other users, and they can optionally edit those tags, essentially while the filming or recording process is taking place. This virtually instant access to the tagging data screen allows the collaborative media indexing system of the invention to be far more efficient than conventional tagging techniques which require time-consuming editing in a separate session after the initial filming operation has been completed.

The tags can be stored in plaintext form, or they may be encrypted using a suitable encryption algorithm. Encryption offers the advantage of preventing unauthorized users from accessing the contents stored within the tags. In some applications, this can be very important, particularly where the tags are embedded in the media itself. Encryption can be at several levels. Thus, certain tags may be encrypted for access by a first class of authorized users while other tags may be encrypted for use by a different class of authorized users. In this way, valuable information associated with the tags can be protected, even where the tags are distributed in the media where unauthorized persons may have access to it.

In another embodiment, a tag analysis system 28 is provided to collaboratively analyze the tags 18 for errors or discrepancies as the tag information is captured. Each of the inputs 22-26 create tags 18 for the same sequence of media 14. Accordingly, certain fields within the multi-field tags 18 should have consistent information being relayed from the inputs 22-26. Specifically, if input 22 is a first camera recording a football game, and input 24 is a second camera recording a football game, then if a spoken tag from input 22 is inconsistent with a spoken tag from input 24, the tag analysis system 28 can read the tag from input 26 and compare it to the tags from inputs 22 and 24 to determine which spoken tag is correct. This collaboration is also done in real time as the tag information is recorded to correct errors via keyboard or voice edits to the tag information.

The tag analysis system 28 may be provided with language translation mechanism which translates multiple languages through the speech recognition into a common language, which is then used for the tags 18. Alternatively, the tags 18 may be stored in multiple languages of the operator's choosing. Another feature of the tag analysis system 28 includes comparing or correlating multi-speaker tags to check for consistency. For example, tags entered by one operator can be compared with tags entered by a second operator and a correlation coefficient returned. The correlation coefficient has a value near “1” if both the first and second operators have common tag values for the same segment of media. This allows post-processing correction and review to be performed more efficiently.

In yet another embodiment, the tag analysis system 28 includes sophisticated tag searching capability based on one or more of the following retrieval architectures: a Boolean retrieval module 34, a vector retrieval module 36, and a probabilistic retrieval module 38 and including combinations of these modules.

The Boolean retrieval module 34 uses Boolean algebra and set theory to search the fields within the tags 18 stored in the tag database 30. By using “IF-THEN” and “AND-OR-NOT-NOR” expressions, a user of the retrieval architecture 32 can find specific values within the fields of the tags 18. As illustrated in FIG. 4, a plurality of fields 40 located within a tag 18 can be searched for work or character matching. For example, a Boolean search using “Word A within 5 fields of Word B” will produce a set of results 42.

The vector retrieval module 36 uses a closeness or similarity measure. All index terms within a query are assigned a weighted value. These term weight values are used to calculated closeness, i.e., the degree of similarity between each tag 18 stored in the tag database 30 and the user's query. As illustrated, tags 18 are arranged spatially (in search space) around a query 44, and the closest tags 18 to the query 44 are returned as results 42. Using the vector retrieval model 36, the results 42 can be sorted according to closeness to the query 44, thereby providing a ranking of results 42.

In a variation of the vector retrieval module 36, known as latent semantic indexing, synonyms of a query are mapped with the query 44 in a concept space. Other words within the concept space are then used in determining the closeness of tags 18 to the query 44.

The probabilistic retrieval module 38 uses a trained model to represent information sets that are embodied in the tag content stored in tag database 30. The model is probabilistically trained using training examples of tag data where desired excerpts are labeled from within known media content. Once trained, the model can predict the likelihood that given patterns in subsequent tag data (corresponding to a newly tagged media broadcast, for example) correspond to any of the previously trained models. In this way, a first model could be trained to represent well chosen scenes to be extracted from football games; a second model could be trained to represent well chosen scenes from Broadway musicals. After training, the probabilistic retrieval module could examine an unknown set of tags obtained from database 30 and would have the ability to determine whether the tags more closely match the football game or the Broadway musical. If the user is constructing a documentary featuring Broadway musicals, he or she could use the Broadway musicals model to scan hundreds of megabytes of tag data (representing any content from sporting events to news to musicals) and the model will identify those scenes having highest probability of matching the Broadway musicals theme.

The ability to discriminate between different media content can be considerably more refined than simply discriminating between such seemingly different media content as football and Broadway musicals. Models could be constructed, for example, to discriminate between college football and professional football, or between two specific football teams. Essentially, any set of training data that can be conceived and organized can be used to train models that will then serve to perform subsequent scene or subject matter pattern recognition.

The Boolean, vector and probabilistic retrieval modules 34-38 may also be used individually or together, either in parallel or sequentially with one another to improve a given query. For example, results from the vector retrieval module 36 may be fed into the probabilistic retrieval module 38, which in turn may be fed into the Boolean retrieval module 34. Of course, various other ways of combining the modules may be employed.

The description of the invention is merely exemplary in nature and, thus, variations that do not depart from the gist of the invention are intended to be within the scope of the invention. Such variations are not to be regarded as a departure from the spirit and scope of the invention.

1. An indexing system for tagging a media stream comprising:
at least one input that provides information for defining at least one tag;
a tagging system for assigning said at least one tag to the media; and
a collaborative tag handling system for dispatching said at least one tag to a plurality of individuals for review.

2. The indexing system of claim 1, wherein at least one input comprises at least one speech input, and said tagging system includes a speech recognition system.

3. The indexing system of claim 2, wherein said speech recognition system includes a translation component that translates multiple languages into a common language, and said common language is stored in the said at least one tag.

4. The indexing system of claim 2, wherein said speech recognition system stores multiple languages within said at least one tag.

5. The indexing system of claim 4, further comprising tag information feedback to a user for editing, deleting, and adding said information in said at least one tag.

6. The indexing system of claim 1, wherein said at least one tag is comprised of a plurality of fields, each of said fields storing information from said at least one input.

7. The indexing system of claim 1, wherein said at least one tag includes a pointer for associating said at least one tag to a timeline of the media.

8. The indexing system of claim 1, further comprising a tag analysis system comparing the information from each of the said at least one input to determine and correct inconsistencies therein.

9. The indexing system of claim 1, wherein said at least one input includes at least one sensor for creating an attribute in said tag.

10. The indexing system of claim 9, wherein said at least one tag includes a confidence value associated with said attribute.

11. The indexing system of claim 1, wherein said at least one tag includes a label identifying a language of said at least one tag.

12. The indexing system of claim 1, wherein said at least one tag includes a label identifying a source of said at least one tag.

13. The indexing system of claim 1, wherein said at least one tag includes an attribute for assigning a copyright designation therein.

14. The indexing system of claim 1, wherein said at least one individual comprises an individual that provides said at least one input.

15. The system of claim 1 wherein said tagging system includes an encryption mechanism to encrypt said at least one tag.

16. An indexing system for tagging a media stream comprising:
at least one input providing information to define at least one tag;
a tagging system for assigning said at least one tag to the media;
a tag database for storing said at least one tag and the media;
a tag analysis system comparing the information from each of the said at least one input to determine and correct inconsistencies therein; and
a retrieval system for searching said tag database by analyzing said tags and returning results.

17. The media indexing system of claim 16 wherein said retrieval system uses a Boolean retrieval model.

18. The media indexing system of claim 16 wherein said retrieval system uses a vector retrieval model.

19. The media indexing system of claim 16 wherein said retrieval system uses a probabilistic retrieval model.
